(19) United States
(12) Patent Application Publication
(10) Pub. No.: US 2010/0145771 A1
(43) Pub. Date: Jun. 10, 2010

(54) SYSTEM AND METHOD FOR PROVIDING SERVICE OR ADDING BENEFIT TO SOCIAL NETWORKS

(76) Inventors: Ariel Fligler, Hod-Hasharon (IL); Carmit Sahar, Tel-Aviv (IL)

Correspondence Address: Pearl Cohen Zedek Latzer, LLP, 1500 Broadway, 12th Floor, New York, NY, 10036, US

(21) Appl. No.: 12/531,355

(22) PCT Filed: Mar. 16, 2008
(86) PCT No.: PCT/IL08/00365

§ 371 Date: Feb. 11, 2010

Related U.S. Application Data
(60) Provisional application No. 60/918,035, filed on Mar. 15, 2007.

(51) Int. Cl. G06Q 10/00; G06Q 90/00; G06Q 50/00; G06T 11/20

(52) U.S. Cl. 705/10; 705/7; 705/14.25; 705/319; 345/440

(57) ABSTRACT

A system and method for enhancing the revenue and/or efficiency of a network service is disclosed. The system constructs a graph of a social network in which users are capable of two-way communication with other users, the network service provider, or other entities such as advertisers. Using such methods as social VIP ranking, the system is capable of performing a variety of analyses, the results of which provide the network service provider insights on how to best perform such tasks as monitoring and enhancing campaign effectiveness, identify fraud, optimize resource allocation and ensure the quality of network management.

### BACKGROUND OF THE INVENTION

The advent of electronic communication has spurred the growth of the field of Social Network Analysis (SNA). The huge repositories of email, cellular, and other forms of electronic communication can be analyzed with the intent of providing insight into patterns in human interaction, at a level of detail never possible before.

A social network can be represented as a graph G=(V,E), where the V vertices (also known as nodes) represent the people participating in the social interaction and the links or edges E connect vertices between which there was communication. When one of the vertices is the originator of the communication and the other is the receiver, the graph is said to be directed and its directed edges are known as arcs. Otherwise, the graph is said to be undirected.

A directed graph of a social network of twelve participants is depicted in FIG. 1, where the participants are labeled by letters A-G and connections by arrows.

Several basic definitions are important with reference to a social network:

Degree—the degree of a vertex is the number of vertices to which it is connected. The “in degree” relates to the number of incoming connections, whereas the “out degree” relates to the number of outbound connections. Thus, in FIG. 1, the “in degree” of node C is 1, and its “out degree” is 6.

Density—the density of a network is the number of edges present as a percentage of all possible edges (connecting all vertices).

Distance—the distance between two vertices is the smallest number of steps they are from each other. For example, in FIG. 1, the distance between nodes A and F is 2.

Hub—a hub is a vertex connected to many others, i.e., a user who sends to many people and/or receives from many people. In FIG. 1, vertex C is an out hub, and vertex E is an in hub.

Authority—an authority connects hubs.

Centrality—this measure identifies the position of a vertex in the network topology.

Closeness centrality—refers to the inverse of the distance of a vertex from every other vertex in the network.

Betweenness centrality—refers to the number of shortest paths connecting every pair of vertices, which pass through a certain vertex (or edge).

Cluster—this is a group of vertices in the network, which are more densely connected among themselves than to other vertices in the network. For example, in FIG. 1, A-G form one cluster and X-Z form another cluster. In fact, X-Z are fully interconnected making this cluster a clique.

The above concepts are defined herein intuitively, but their formal mathematical definitions are well known. See, for example, M. E. J. Newman, The Structure and Function of Complex Networks, SIAM Review 45, 167-256 (2003); and Bruce Hoppe, Introduction to Network Math, May 2007, available at http://behoppe333.googlepages.com/introductiontonetworkmath.

Many other concepts have been developed for the analysis of social networks; however they are not pertinent for what follows. Specifically, Social Network Analysis has not been applied in the past for service adoption management analysis to increase and assure the adoption of person-to-person based services.

The graph representation of social network is easily constructed from the communication logs maintained by mobile providers without loss of generality. For example, one could build the graph by scanning logs of MMS (multimedia messages by which sound, images or voice can be sent to another user of the mobile system) interaction—if A sends an MMS message to C, then a node for A and C will be created and a directed edge exists from A to C. Based on the level of interaction, a weight can be assigned to the edge to reflect the qualities of the interaction, such as the frequency with which messages are sent, the diversity of messages sent (e.g., images, music), etc. This weight is also known as the strength of the edge.

A well known practice in marketing is to pick out the heavy users or hubs and those connected through the social network to those heavy users, and to target this group of people for marketing campaigns.

Although intuitively this procedure seems very reasonable and with the potential for a high return on investment, it has never been shown that this procedure is necessarily optimal. In fact, better procedures exist for targeting customers for marketing campaigns. See, Kempe, Kleinberg, Tardos, Decreasing cascade model, Influence maximization, Proceedings of the Ninth ACM SIGKDD International Conference on Knowledge Discovery and Data Mining, 2003.

Targeting all hubs is not necessarily very effective since hubs are usually interconnected, and thus the spread of influence is not necessarily maximized by targeting only them. In fact, many other customers are potentially unreachable through a hub. In addition, since targeting each customer can prove to be costly, targeting many interconnected hubs is redundant and wasteful.

To date, no other use has been made of the rich content provided by the social network available from electronic communication logs in increasing adoption.

### SUMMARY OF THE INVENTION

One object of the present invention is to increase the adoption of the usage of services such as, but not limited to, Value Added Services, such as (but not limited to) Multimedia Messaging Service (MMS), mobile instant messaging or online group gaming in a mobile company (but not limited to mobile companies) or any person to person service.

It is another object of the present invention to use players' positions within their social environment, coupled with properties of said social environment, in order to unearth barriers limiting adoption of a varied array of services.

It is a further object of the present invention to promote the efficient and cost-effective administration of a network service by providing a novel means to prioritize the allocation of limited resources, such as customer care actions, incentives and benefits, hardware replacements, etc. based on a ranking of users, employing social network analysis.

The system, as described in detail below, can harness social network analysis to create a rich repository of enhanced capabilities in the facilitation of usage of a varied array of services, leading to an increase in adoption and continued use of these services. These enhanced capabilities also allow for the efficient management of a customer or user population based on the structure of the graph of the social structure.

It should be noted that for the sake of clarification, examples from the field of mobile communication are given, but the present invention is by no means limited to this area. The present invention is capable of analyzing social networks in a variety of contexts, including fixed-line telephony, VoIP, e-mail, and other internet or mobile-based social networks.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 is a directed graph representing a social network of twelve participants.

FIG. 2 is a flowchart representing an overview of the social network analysis and visual representation creation processes, according to an embodiment of the present invention.

FIG. 3 shows a Social VIP analysis of a social network graph in which a transaction is initiated at node B, according to an embodiment of the present invention.

FIG. 4 is a flowchart outlining the steps of Social VIP analysis, according to an embodiment of the present invention.

FIG. 5A shows a graph of a social network using a communications technology with a relatively high degree of market penetration (e.g., a mature technology).

FIG. 5B shows a graph of a social network using a communications technology with a relatively low degree of market penetration (e.g., a new technology).

FIG. 6 is a flowchart outlining the steps of missing links identification, according to one embodiment of the present invention.

FIG. 7A shows a graph of a social network at four different points in time.

FIG. 7B shows a graph of a predicted future state of the social network in FIG. 7A, according to an analysis performed by one embodiment of the present invention.

FIG. 8 is a flowchart outlining the steps of missing link analysis of a social network, according to one embodiment of the present invention.

FIG. 9 is a flowchart outlining the steps of rank evolution analysis of a social network, according to one embodiment of the present invention.

FIG. 10 is a graph of a social network which contains two groups with incompatible attributes.

FIG. 11 is a flowchart outlining the steps of structural anomaly analysis of a social network, according to one embodiment of the present invention.

FIG. 12 is a flowchart outlining the steps of spam source identification and spam elimination, according to an embodiment of the present invention.

FIG. 13 is a flowchart outlining the steps of fraud detection, according to an embodiment of the present invention.

FIG. 14 is a flowchart outlining the steps of social network analysis to prevent group churn in a service, according to one embodiment of a present invention.

FIG. 15 is flowchart outlining the steps of monitoring and improving marketing campaign effectiveness, according to an embodiment of the present invention.

FIG. 16 is a flowchart outlining the steps of provisioning a new service in a social network, according to an embodiment of the present invention.

FIG. 17 is flowchart outlining the steps of segmenting and profiling a user base of a service, according to an embodiment of the present invention.

FIG. 18 depicts a block diagram of the system of the invention, according to one embodiment of the invention.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer, processor, or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as personal computers, network equipment, stations of a radio system, wireless communication system, digital communication system, satellite communication system, and the like.

Stations, nodes and other devices intended to be included within the scope of the present invention include, by way of example only, local area network (LAN) stations and/or nodes, metropolitan area network (MAN) stations and/or nodes, personal computers, peripheral devices, wireless LAN stations, and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a personal area network (PAN), LAN, wide area network (WAN), or a global communication network, for example, the Internet.

The first step in any social network analysis is constructing the social network graph. The representation of the social network as a directed graph creates a succinct summary of the millions of electronic transactions among the customers.

In constructing the social network graph describing the communication among customers, each customer constitutes a node (vertex) on the graph. Thus, the social network contains as many nodes as there are customers taking place in the analyzed means of communication. If information on communication between customers who are not present in the graph beyond the data that is available, then these missing customers can be included as well in the graph.

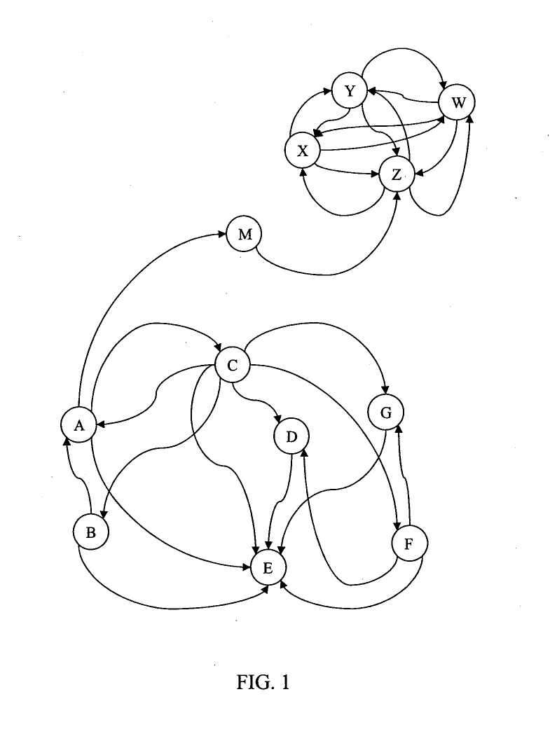

Customers are linked by graph links (edges) whenever they communicate among themselves. If customer A communicated with customer B, a directed link is created on the social network from A to B. Once a graph describing the social network is created, its visual representation would be similar to that of FIG. 1.

The graph is then analyzed to extract well known measures describing its structure, including, but not limited to, the graph metrics listed in the previous section. In addition, the temporal evolution of the social network structure is identified and recorded. This data is then used for adoption management in an innovative way, as described below.

The analysis of a social network can be performed on many levels, depending on the amount of data and information provided. The richer the information, the more comprehensive and detailed is the analysis and the conclusions drawn from it.

Thus, the data available for conducting the social network analysis determines the extent of the analysis. Optimally, the data provided would include the following types:
All transactions data, such as but not limited to: Unique user ID (an MSISDN, an email address, etc.), Transaction type (in the case of mobile networks—voice, SMS, MMS, WAP etc.), Timestamp, Failure indication, Destination (an MSISDN, an email address, etc.), Attachment type (if it exists), and Attachment size (if it exists); and
Enrichment data, such as but not limited to: demographic data, hardware (e.g., handset model), geographical location, other pertinent habits (e.g., mobile gaming habits), and technological fluency (e.g., extent of handset personalization).

Analysis can be performed even when some of these variables are missing. However, for the purpose of building the Social Network, the unique identifier for the sender and the destination must be provided.

In general, the information needed should include but is not limited to: (1) data that reveal details regarding the interaction between individuals and the interaction attributes; (2) data that can qualify the quality of interaction or of individuals; and (3) demographic and other individual attributes that can later be found to be the root cause of a certain behavior.

The system processes the data available from the service provider (such as mobile operator, interactive TV, web ASP, etc.) to construct and analyze the social network graph, and provides recommendations to improve customer experiences with the service, as well as discover opportunities to maximize revenue from the service.

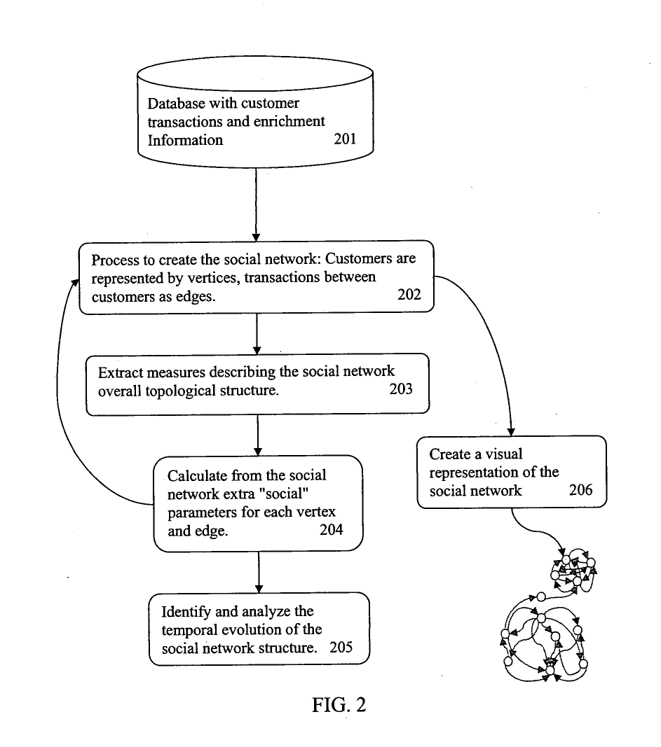

FIG. 2 shows an overview of social network graph creation and analysis, the individual steps of which will be explained in greater detail in the sections that follow. In step 201, the network service provider records in a database the customer transaction data of the type specified above, and inputs this data for analysis by the system. In step 202, the system creates a graph of the social network, in which customers or users are represented by vertices and transactions are represented by edges. The graph may capture a social network encompassing all transactions occurring within a specified period, e.g., a one-month time frame, or upon a certain event, e.g., the deployment of a new service. The system may also graph a social network tracking the propagation of a certain transaction throughout its user base. In addition, the system can use the full range of data collected in step 201 to weight edges based on metrics such as transaction frequency, amount of data exchanged, revenue generated, etc.

In step 203, the system calculates some basic metrics about the overall topology of the graph, such as density, clusterization, average distance, etc. In step 204, the system processes the graph of the social network to calculate extra “social” parameters for each vertex and edge, such as to rank users according to various criteria, and to perform other types of high value analyses to the service provider, as will be discussed below. The service provider can then modify the terms or the implementation of the service, either with respect to one user, a group of users, or the entire user base, in order to improve the service, or enhance revenues. In step 205, the system may track the evolution of the social network over time as the system periodically recalculates the analysis and stores the results in order to perform such tasks as link prediction (what new links are likely to be created), etc. In step 206, the system may optionally generate a visual representation of the graph of the social network, or a portion thereof, to provide a better understanding of the social network to the system user.

The system then provides recommendations to improve customer experiences with the service, as well as discover opportunities to maximize revenue from the service. Using various types of social network analyses, the system provides innovations for increasing adoption and promoting the use of a varied array of services, using the structure of the social network arising from the particular service analyzed, and the position of each individual within this social network and the individual's interaction with his service peers.

### A Social VIP

As referred to above, the system generates a Social VIP, or a ranking of customers according to their position and social attributes in the social network, which is a key concept in harnessing social network analysis in order to increase network service utilization and enhance revenue.

Adoption management is a business process done at the granularity of the single customer, hence for any non trivial customer base, adoption management incurs costs due to resolution actions such as campaign promotions. Further, approaching a customer may create a hindrance and thus should be made with care and attention to avoid spamming the relationship with the customer. Thus, social rating can increase the ROI and optimize actions related to adoption management by attaching a social VIP rating and prioritizing which customers to approach in service adoption management resolution actions. As a general statement, social VIP rating is an innovation in viewing customers beyond their individual financial value, in the context of how they influence their social neighborhood. Namely, moving from adoption management of single customers to adoption management of groups of customers understanding that in P2P services, the single customer can influence the adoption of his peers.

Traditionally, customers are graded according to the value of their monthly bill, LTV (life time value), Probability of Churn and other financial parameters. See, Paul D. Berger et al., Customer Lifetime Value: Marketing Models and Applications, Journal of Interactive Marketing, Volume 12, Issue 1, Pages 17-30 (March 1999); and Roland T. Rust et al., Driving Customer Equity: How Customer Lifetime Value Is Reshaping Corporate Strategy, Free Press (2000).

Special offers and campaigns are presented to customers based on these parameters. However, a customer has value beyond these financial parameters. FIG. 1 presents such a case. Customer M is not connected to many others and thus may be perceived to have a low financial value. As a result, traditionally, M would receive very little attention from the service provider. However, under the system as described herein, M constitutes a bridge between two large communities. Information and content passing through M propagates deeply, potentially creating a much bigger impact than M's financial value.

The system uses demographic and financial information as is traditionally used for determining a customer's rank. But, in addition to this, the system also uses information extracted from the social network topology to grade those customers who are most likely to increase overall usage or that are likely to degrade overall usage.

As was mentioned in the background section above, the current practice used by social network analysts for the purpose of increasing adoption/usage is to target only hubs. The system of the present invention bases social VIP status on the overall position of the individual within the social network and the attributes of the people who are interacting. Targeting customers based on their social value will eventually be translated to increased revenues due to higher group adoption. Apart from users, links may also receive a social VIP grade to reflect a relationship of importance.

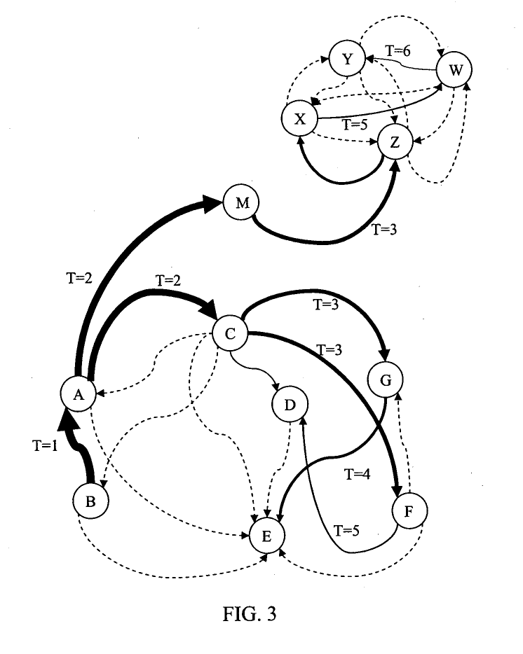

The system also attaches social value to transactions or actions made by customers. FIG. 3 shows how a transaction worth $1 initiated at node B is propagated through the network, resulting in a much greater value for the service provider. Each edge is labeled by the time at which it was created. The edges are coded by a progressively thinner line thickness, as they infect the next node at a later time. Thus, first level communications (T=1) have the greatest thickness, second level communications (T=2) have a somewhat lower level of thickness, and so on, until the lowest level of communications (T=6), which is shown in the thin line between W and Y. The broken lines represent links in the social network over which the $1 initial transaction does not propagate at all. As shown in FIG. 3, a user may send an MMS message worth $1 to a friend. If this message eventually circulates through viral propagation to other customers, the $1 message will have an overall financial value much greater than the financial value of the transaction itself.

The system thus attaches a social rating to users' transactions or actions reflecting their qualities. A transaction's social rating is based on the context (i.e., the group of customers interacting and the potential customers that may receive the data flowing) in which it is made, the social attributes of the customer initiating it, and the attributes of the customer's peers. For example, the following criteria can used by the system to rank a transaction's importance:
The transaction was initiated from an authority, or a person whose transactions are highly regarded by others.
The transaction was initiated within a group of customers who have demonstrated a high propagation of information between them in the past.
A combination of two qualities such as the transaction was targeting a person who is an authority, or a connector to a large group of other customers who have been shown to be propagating data in the past.

Other criteria known to one skilled in the art of graph theory analysis may also be employed.

The social VIP rank is used to increase adoption. The parameters pertinent to the inclination of a customer for adoption are:
1. Demographic information such as (but not limited to) age group, geographic location, etc.;
2. Financial parameters such as monthly bill;
3. Technical information such as handset type (in the case of mobile networks);
4. The influence of this customer on his/her neighbors in the social network;
5. The influence on this customer of his/her neighbors in the social network; and
6. The propensity of information arriving at a certain customer to further diffuse in the network.

The system integrates these parameters to provide a social rank.

It should be noted that the exact formula for the social rank is preferably heuristically determined, but may employ artificial intelligence algorithms (which may be stochastic) or traditional deterministic formulae. For example, the way that the age of a customer determines that customer's level of adoption greatly depends on the particular service analyzed. A time consuming service that is used mainly for fun might be primarily adopted by the 12-18 age group, whereas a service requiring greater technical skills and higher financial expenditure might be primarily adopted by the 25-34 age group. The correlation between the demographic, financial and technical parameters (items 1, 2 and 3 in the preceding paragraph) and the level of adoption can be discovered in a variety of ways known from the theory of statistics, such as regression analysis. Other ways of detecting the correlation between these parameters and the level of adoption will be apparent to one skilled in the art.

Items 4, 5 and 6 from the preceding list are extracted from the social network itself. There are currently debates in the academic community about the best way to measure a node's influence on its neighbors as derived from the social network topology. Current algorithms include naïve methods such as counting the in and out degree of nodes, eigenvector methods such as Google's PageRank (see, Lawrence Page et al., The PageRank Citation Ranking: Bringing Order to the Web,” Technical Report, Stanford University, 1998), HITS by Kleinberg 1999 (Jon M. Kleinberg, Authoritative Sources in a Hyperlinked Environment, Journal of the ACM 46 (1999)), etc., visual methods (such as Brandes et al., Visual Ranking of Link Structures, Journal of Graph Algorithms and Applications, Vol. 7, No. 2, pp. 181-201 (2003)), flow methods, etc. Other algorithms may also be employed.

However, in a preferred embodiment, the most suitable method used will depend upon the precise scenario which the social network represents. The rank most suitable for a social network representing the collaboration of researchers on academic papers is not the same as the rank most suitable for a social network representing the collection of web pages on the internet.

Thus, the exact method used will depend on the service and also on the type of action that the information needs to support. For example, a service provider may be interested in increasing the adoption of a specific small group of customers who may be distributed in a certain cluster, by which the plain inclusion of a customer in this cluster will set its priority as very high.

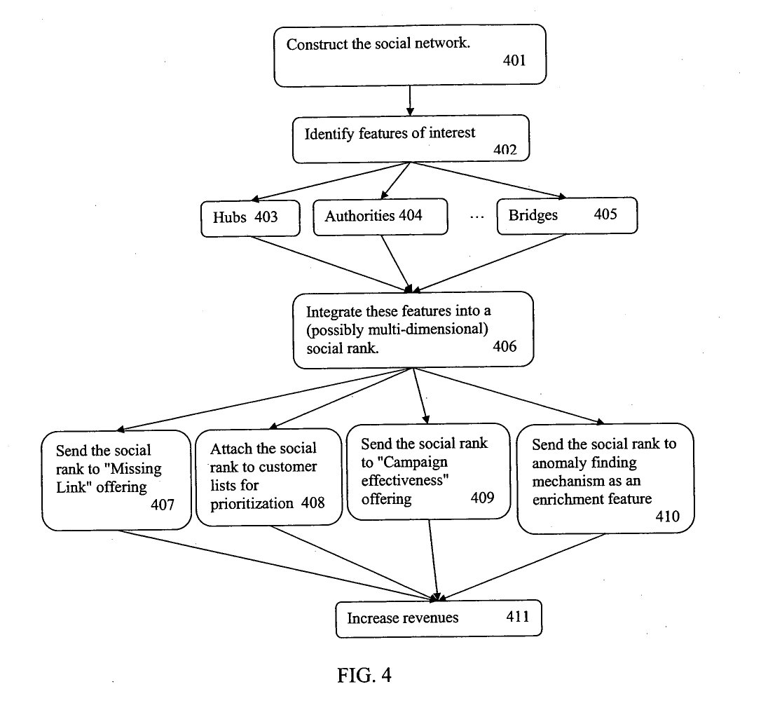

FIG. 4 shows a flowchart outlining the steps of social network VIP analysis. After the social network is constructed in step 410, the system identifies the features of interest in step 402, namely whether the vertices can be categorized as hubs (as determined in step 403), authorities (as determined in step 404), or bridges (as determined in step 405) or other social VIP rankings, such as measures of centrality, closeness centrality an betweenness centrality, among others. “Hub” and “authority”, which connects hubs, are defined above. Thus, even though a person may not have many connections, the fact that one of his connections is a hub makes him quite important and he is ranked higher on the “authority” scale.

A “bridge” connects two separate clusters. A user may have just a few connections and still be very important for the amount of traffic generated in the network. This happens when the user's connections are situated in different “clusters”. For example, a user who has just one friend from his office and one friend from the gym is not very well connected. However, when that user receives interesting content from his gym friend, he may send it to his office friend who then sends it to some other people at work and this eventually percolates to everybody in the “office cluster”. This user has few friends, and any of the traditional ways for calculating his value would result in a low value. However, using the system as described herein, this user's mere two connections create a large amount of traffic in the network, and we conclude that he should be assigned a high importance.

It should be noted that the examples “bridges”, “hubs” and “authorities” are discussed herein because their significance is easy to explain non-mathematically. It will be understood by a person skilled in the art that other ranks, which are not necessarily the hub, can be very significant in the increase of network usage, increased adoption, etc. As discussed below, there are many other social network criteria that may be used in social ranking.

Once these features are determined, they are integrated into a social ranking, as shown in step 406. Other features and ranking criteria known to those skilled in the art may also be employed. In a preferred embodiment, the social ranking is multi-dimensional, i.e., each of the different ranks calculated may be employed individually or in various combinations for different aspects of the analysis. Each of the individual features of interest indicated above (e.g., hubs, authorities, bridges, etc.) has specific mathematical definitions and is identifiable using specific algorithms, which are well known in the art. However, the system is not limited to ranking criteria that requires a precise mathematical definition, and may employ any ranking criteria, including custom criteria created for specific applications. Newer ranking criteria may also be easily employed by the system with no loss of functionality. The features of interest indicated above are provided as an example, and do not preclude other proprietary features from being incorporated into the system's social VIP ranking algorithm to rank the people in the context of their place in the network. The resulting VIP social network ranking is very different than the traditional ranking, which leads to many new insights.

In steps 407-410, the VIP social ranking can be used for various commercial purposes, such as in a “Missing Link” offering, in prioritizing customer lists, in “Campaign Effectiveness” offerings, and in an anomaly finding mechanism, among others, as described hereinbelow.

In step 411, the network service provider is able to increase revenues, either directly by increasing the adoption and usage rate of various services, or indirectly by enhancing the quality and efficiency of the network service, which may promote overall customer satisfaction, decrease operating costs, and prevent churn. This may be accomplished by implementing certain technical changes to the network itself, or by modifying the terms of service with respect to a customer or a group of customers, as indicated by the results of the analyses described hereinbelow.

### Missing Links Identification

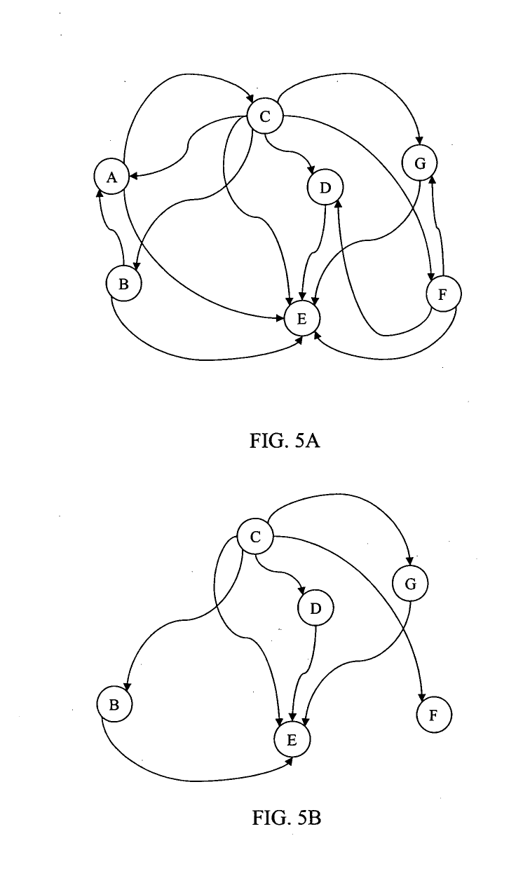

The identification of missing links is achieved by comparing the social network with respect to two distinct communication technologies. In the case of mobile communication, for example, we may compare usage of MMS (which is a new technology with few users out of the potential market) to that of voice and Short Message Service (SMS), which are two mature technologies with high penetration. This is depicted in FIGS. 5A and 5B.

In FIG. 5A, the social network represented by the graph indicates the use and adoption of a technology with a relatively high adoption rate. Likewise, the graph in FIG. 5B represents the use of a technology with a relatively low adoption rate. FIGS. 5A and 5B may indicate a mature and a new communications technology, respectively, but more generally shows any two technologies with different adoption rates. The system detects that user A does not use the new technology at all, while user F does not send data or initiate transactions using the new technology.

The system detects links that are present or have a high social rank in the social network representing the mature communication technology but absent or have a low social rank in the social network representing the advanced communication technology. Thus, gaps are identified in the non-mature technology. Further, the system can grade each link by its value to the mobile company. The system may employ metrics such as the ARPU (average revenue per user) or LTV (life time value) of the users involved, the frequency with which the two users interact, and/or from the social VIP rank calculated. A high social VIP rank calculated from the social network representing the mature technology indicates that the customer has a high degree of impact on the network traffic. Therefore, it would be beneficial to include the customer also in the social network for the new technology. By integrating this value together with the information about the missing links, the system can prioritize the missing links according to their social value and detect adoption opportunities. For example, the system can determine which customers to approach with marketing campaigns to move interaction to a more advanced and profitable technology, such as moving from SMS to MMS in mobile communication. In addition, missing links can be analyzed by the system to search for possible usage barriers—namely, knowing that the social interaction exists between A and B only in the mature technology but not in the new service may hint to a problem that prohibits the usage of the service between the two customers.

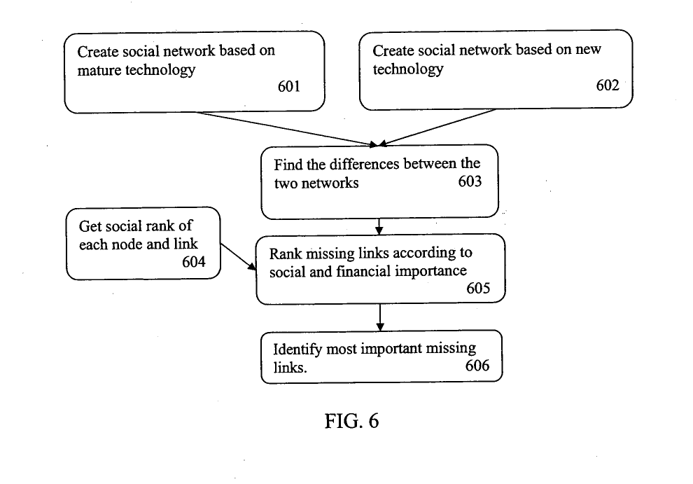

The analysis process is summarized in FIG. 6. In step 601, the system creates a graph of a social network based on a mature technology, e.g., a type of communication or service with a high user adoption rate, using the same method described above. In step 602, the system then repeats the process and creates a graph of a social network based on a new technology, e.g., a type of communication or service with a relatively low level of user adoption. In step 603, the system compares the resultant graphs generated in steps 601 and 602 to determine the differences, which may be considered the missing links, which may indicate which users of the network either cannot use the new technology (due to incompatible hardware, for example) or choose not to use the new technology. In step 604, the system uses social VIP analysis as described hereinabove to rank the users and the links between them according to various metrics, such as usage rate and profitability. The social VIP analysis may be focused only on those portions of the social network graph identified by step 603, or may be performed on the entire social network graph. In step 605, the system ranks the missing links identified by step 603 to determine their social and financial importance. In step 606, the system identifies the most important missing links.

These links are either a potential source of increased revenue by themselves, or represent, by virtue of their position in the social network, an opportunity to increase adoption in clusters of users accessible via those links. The network service provider may then act on this information by resolving any technical difficulty that may be preventing adoption of the new technology or by providing incentives to certain users that may increase adoption of the new technology in the social groups to which those users belong.

### Link Prediction

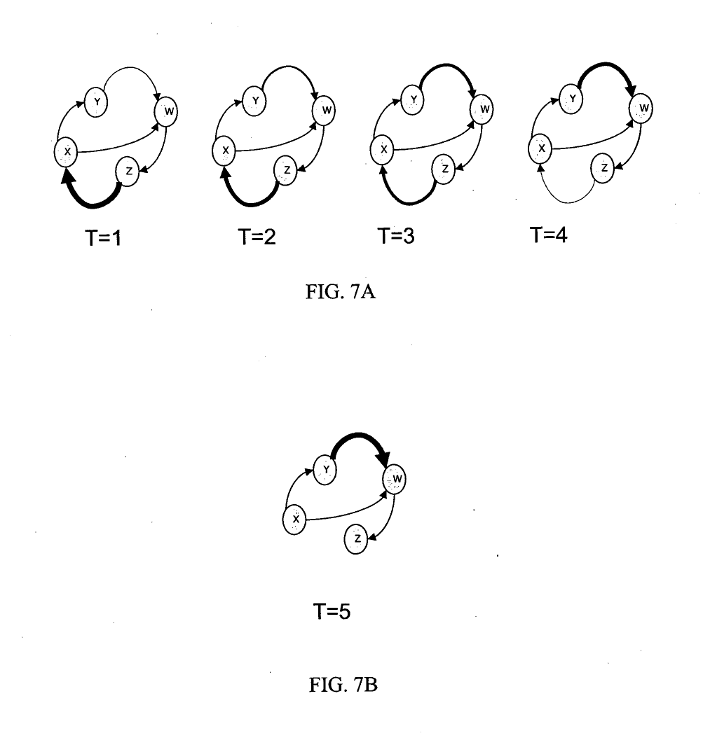

Using data mining techniques (either by some time-series prediction technique, or by a different method such as logistic regression, nave Bayes, etc.), the system can also predict with high accuracy new links which could form, or existing links whose strength can change, in a prescribed future period of time. Link strength, or edge strength, is defined in the background section above. This ability is independent of the Missing Link capability described above since Link Prediction can be done on each social network independently (in the context of the example given above, we can make the prediction about links in the MMS social network without using the SMS network). A scenario, too simple to be realistic and used only for illustration, is depicted in FIG. 7A.

In FIG. 7A, we see that on progressive time steps, the link Y→W strengthens. On the other hand, the link from Z→X weakens over time. This time progression provides an easy scenario for predicting the network at time T=5. The prediction is shown in FIG. 7B.

In FIG. 7B, the link Y→W grows stronger than before. Furthermore, Z's links to X have weakened over time to the point of collapse. It should be noted that this is a very simple scenario, and in real life more complicated situations will be involved. However, in all cases, the principle for link prediction is based on discovering the patterns of link variation over time.

Link prediction is achieved by analyzing the structure and time evolution of the social network, as well as the analysis of demographic information. The prediction is usually made for the top few percent of users with special attributes such as high social VIP, hubs, heavy usage, etc. The links predicted are used for increasing adoption by identifying opportunities and failures and understanding how marketing campaigns can influence the social network. In addition, this can be used for impact analysis and fine tuning of marketing efforts.

Negative developments along time can also be discovered (like link deletion) to find evolving problems in a certain network area. For example, by tracking over time the neighborhood of a link which has died out, after shocks may be discovered in the shape of a decrease in the level of interaction. Using the network structure, one can continue to analyze how areas further down the graph will display a decrease in the level of interaction in a ripple effect, thus quantifying the potential damage.

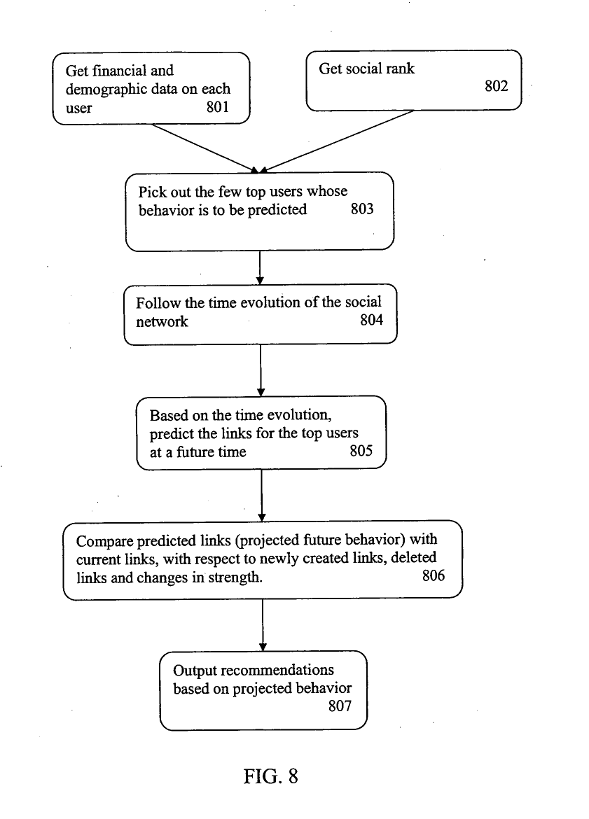

The analysis process is summarized in FIG. 8. In step 801, the service provider compiles financial and demographic for each user from its billing records, customer databases, and transaction logs. In step 802, the system performs social VIP analysis to rank each user, using the method described above. In step 803, the system chooses a subset of the network service's user base to analyze in order to predict their behavior. These users are chosen based on either their own personal usage of the network service, or based on their position in the social network, or some combination thereof. Other methods of selecting which users to analyze will be apparent to one skilled in the art. In step 804, the users identified in step 803 are monitored over time in order to determine persistent or recurring patterns in their usage of the network service. In step 805, the system attempts to predict the links for the users identified in step 803 for a given point in the future. In step 806, the system compares predicted links with current links, with respect to newly created links, deleted links, and changes in link intensity. In step 807, the system outputs recommendations based on projected future behavior of the users identified in step 803. The service provider can then modify the terms or the implementation of the service, based on these recommendations, in order to improve the service, or enhance revenues.

### Rank Evolution

From the time evolution of the network as described the preceding section discussing Link Prediction, a social temporally evolving rank can also be calculated. This rank is based on the precise sending time of every single communication message. Temporally evolving rank can be used to automatically detect trends of individuals over time, as well as changes in the relative ranks. This can be used like Link Prediction for the identification of opportunities and failures and understanding how marketing campaigns can influence the social network For example, the following trends in network evolution could be tracked:
A customer's number of incoming and outgoing links. A decrease in any of these attributes could indicate a problem that prohibits communication with existing relationships. For example, in the case of mobile communication, a problem in the user handset, or interest in service or value problems.
The growth rate of a certain cluster—the system could detect that over time a certain cluster's growth rate decreases. This could be due to natural reasons (e.g., Dunbar's Law of limitation of 150 members in any close social group), or due to some problem such as a change in the rules (innovation of service, value, competing services that share the same wallet share) that govern growth.

Other trends that may be tracked over time will be apparent to those skilled in the art.

It should be noted that, for the purpose of trend identification, it is usually useful to first determine which trends it is most pertinent to discover—i.e., whether it is a drastic change in a customer's links, or a change in the growth rate in certain regions of the network, etc. But even when no specific trends are investigated, the graphs representing the social network at different times can be compared to find the significant changes.

Once trends have been identified, it should be determined (either automatically or by the service provider's operators) whether these changes are for the better or for the worse, what are the actions that brought about these changes (for example, a successful campaign in the case of an increase in the volume of communication, a sharp rise in rates in the case of a decrease of communication), and then appropriate measures are consequently taken by the operator.

It should be noted that changes can be brought about by external factors that are completely unrelated to the service provider. For example, a rise in the volume of communication can be due to time of day or day of week, holidays, major events (catastrophes) etc. Similarly, a fall in the communication volume can be due to a successful campaign of the competitors or due to a user's personal reasons.

The system includes functionality that allows the system to find associations among previously unknown factors. Thus, the system can detect customers that show a similar temporal rank evolution and detect the common factors between them.

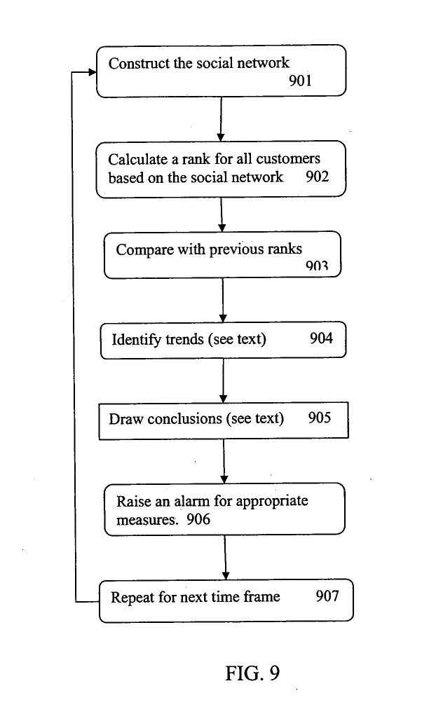

The analysis process is summarized in FIG. 9. In step 901, the system creates a graph of the social network, as described above. In step 902, the system then calculates a social VIP rank for each user of the network service. In step 903, the system compares the rank of each user with any previously calculated ranks, and notes any significant changes. In step 904, the system identifies any trends of the type noted above. In step 905, the system attempts to draw conclusions based on these trends. In step 906, the system alerts the network service provider of any issues that may require taking appropriate measures. Such measures may be technological in nature, or may require the network service provider to alter the terms of service with at least a portion of the user base in order to maintain revenue growth. In step 907, the system repeats the rank evolution analysis for the next time frame, and returns to step 901 to construct a new graph of the social network for this new time frame.

### Structural Anomalies

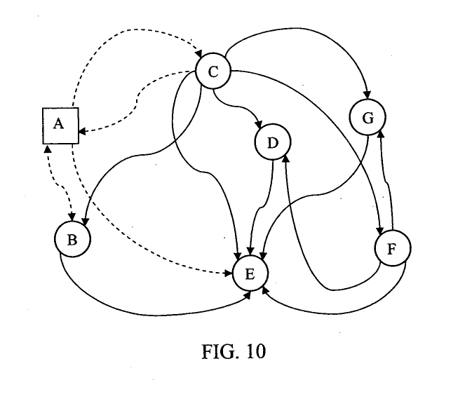

A search may also be made for non homogenous attributes of connected components (more specifically, clusters) that can create adoption barriers or restrict usage, as depicted in FIG. 10. These may be known as structural anomalies.

FIG. 10 depicts a cluster of users belonging to a larger graph which is omitted for clarity. In this cluster, users with one value of an attribute are denoted by circles, while users with a different, incompatible value of that same attribute is denoted by squares. The links which are affected by this incompatibility are denoted with dotted lines

By the nature of a cluster, members within a cluster often communicate among themselves. These connections could be strengthened by removing attributes that prohibit adoption. Examples of such structural anomalies are incompatible pricing plans (e.g., some members of the cluster get a special weekend rate and the others do not) or incompatible hardware (e.g., in the case of mobile networks, incompatible handsets or handsets that have different capabilities such as different image quality). Other types of incompatibilities or structural anomalies will be apparent to those skilled in the art. By detecting and removing these anomalies, adoption will increase within the cluster. As an example, if user A has a handset with lower image quality, messages that are being sent from A to B will have low quality even if B has a higher quality handset. Needless to say, if B forwards this message, the message quality will remain as low as A's message quality, which may influence the value that customers see in this service.

Another structural anomaly is identifying clusters with homogenous problematic attributes. For example, say a cluster is found within which the only type of MMS messages sent is images, with no music being sent. A possible resolution process is to tease some “strong” members in the cluster (like authorities or hubs or any users with a high social rank) to start using music messages as well to ignite its usage in the cluster.

Cluster identification is carried out using one of the standard procedures known in the field of social network analysis, such as betweenness centrality clustering, voltage based methods, random field Ising models etc. See, for example, M. E. J. Newman, Finding community structure in networks using the eigenvectors of matrices, Physical Review E, 2006; Wu et al., Finding communities in linear time: a physics approach, Journal The European Physical Journal B—Condensed Matter and Complex Systems, Volume 38, Number 2, March, 2004.

It can be inferred that identifying the anomalies is the hardest part in this procedure. If the anomaly is known ahead of time (for example—finding all clusters where the types or sizes of communications sent are not distributed like in the general population), then it is not difficult to compare histograms of different parameters of the communication sent within different clusters. However, if the anomalies are not known ahead of time (as is the case in the most intriguing circumstances), then more complicated data mining tools must be employed in order to unearth and identify these intractable situations. TAO Proactor™ technology, which is described in U.S. Patent Application Publication No. 2006/0229931 A1, published Oct. 12, 2006 and entitled “Device, System and Method of Data Monitoring, Collection and Analysis”, has the ability to find such previously unknown anomalies. Other data mining systems and techniques may be employed as well.

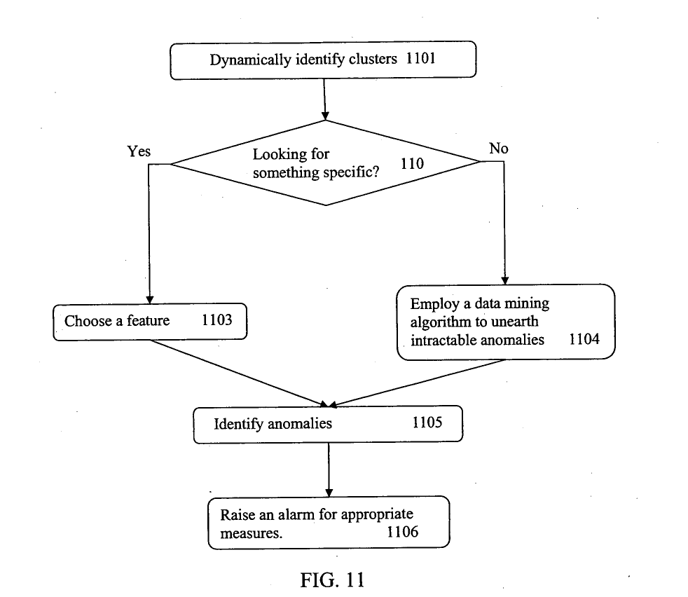

The analysis process for determining structural anomalies is summarized in FIG. 11. In step 1101, the system dynamically identifies clusters of users based on the topography of the generated social network graph. In step 1102, the system provides the option to either search for a known anomaly, such as handset incompatibility, or to dynamically find incompatibilities. If a specific anomaly is to be detected, the system can receive instructions on which analysis to perform in step 1103. Alternatively, if no specific anomaly is to be detected, the system may employ a data mining algorithm, which may employ artificial intelligence, to identify anomalies too subtle or too rare to be identified by a human. In step 1105, the system identifies anomalies, whether of a type specified in step 1103, or uncovered by a data mining algorithm in step 1104. In step 1106, the system alerts the network service provider of any issues that may require taking appropriate measures. Such measures may be technological in nature, or may require the network service provider to alter the terms of service with at least a portion of the user base in order to maintain revenue growth.

The system may employ social VIP analysis to prioritize the discovery and resolution of structural anomalies.

### Identifying Sources of Spam and Other Types of Malware

The system may also identify sources of SPAM and other malware. As the usage of electronic communication (such as mobile communication) increases, so will its misuse. While spam or unsolicited junk mail is a mere annoyance in the case of electronic mail, in mobile communication it can be a true irritation, causing a most unwelcome distraction, and may result in users abandoning advanced services. The system tracks down the spread of spam, discovers its source and obstructs its spread. Due measures can then be taken by the mobile company against spammers. With the knowledge gained by the system about the spread patterns of spam, restrictions can be imposed by the mobile company on the use of advanced services messages, to prevent the unwelcome spamming of thousands of unsuspecting subscribers. With the continued use of advanced services, malware such as viruses, Trojan horses, and worms also has the potential of becoming widespread in mobile network, with devastating consequences. Additionally, the network service provider may wish to stop the spread of certain content for legal reasons, such as copyright violations or other inappropriate content. The system can stop the spread of such objects, and contain the problem at an early stage. Additionally, the system may employ social VIP ranking to prioritize the identification of the sources of such content.

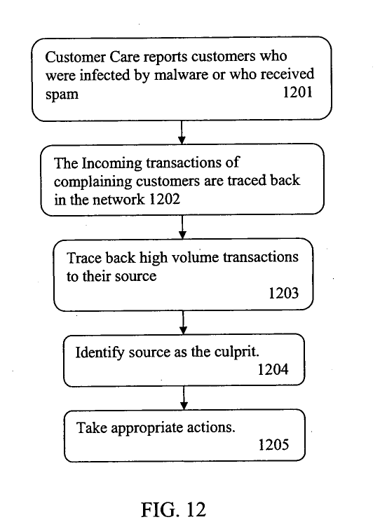

The analysis process for identifying sources of SPAM and other malware is summarized in FIG. 12. In step 1201, customer service representatives of the network service provider are informed by users of incidents of malware or SPAM. Alternatively, the network service provider may also become informed of malware or SPAM through such methods as network logs, SPAM filters, or other techniques known to one skilled in the art of network administration. In step 1202, the system employs the graph of the social network to trace back the incoming transactions of the complaining users. In step 1203, the system then traces high volume transactions (i.e., transactions with a large number of recipients) back to their source. In step 1204, the system correlates the sources of high volume transactions traced in step 1203 with those transactions traced back from the complaining users in step 1202 to identify the source of the malware or spam. In step 1205, the network service provider may then take the necessary actions against the source of the malware or SPAM, including fixing the handset, cancelling the culprit's service, or taking legal action.

### Identification of Fraud

The system may also detect and identify instances of fraud. Fraud, or the takeover of an unsuspecting subscriber's resources (for example, and without loss of generality, in the case of mobile services the takeover of the subscriber's line, even without stealing the handset, using it for long distance expensive calls), is a source of loss of revenue for mobile companies. Fraud is usually detected by analyzing patterns of usage such as time of day, geographical location, length of calls etc. The system contains a novel fraud detection mechanism, based on the detection of variations in social network patterns, such as abrupt changes in users' network connectivity. The sudden addition of many new links to a user's social network neighborhood is a telltale sign of fraud. The system employs social VIP analysis, to quickly summarize and track these abrupt changes.

It should be noted that SPAM, malware and fraud are “hindrance barriers” that might influence adoption to the same extent as technical difficulties.

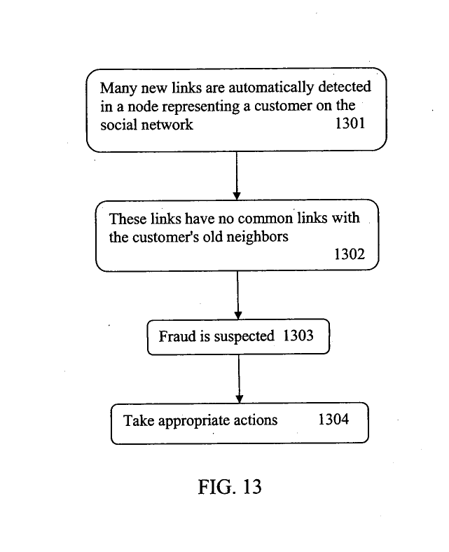

The analysis process for fraud detection is summarized in FIG. 13. In step 1301, the system determines that for a given user in a social network, the graph shows many new links that did not exist previously, i.e., an abrupt change in social VIP rank. In step 1302, the system determines that these new links may, for example, connect two previously unconnected clusters. That is, users accessible through these new links have no connection to anyone that the given user has had any prior contact. Alternatively, the new links may demonstrate some other social network topology inconsistent with normal use, as recognized by one of ordinary skill in the art. In step 1303, the system processes the results from steps 1301 and 1302 and determines whether there is sufficient reason to suspect fraud. In step 1304, the system alerts the network service provider of the possibility of fraud, at which point the user may be contacted and the service may be canceled.

### Prevention of Viral Collapse

The system may also prevent viral collapse of systems. One of the major concerns of many companies is customer churn, where the usage patterns of a subscriber gradually change leading to abandonment of the service. The problem of churn can be exacerbated when, through negative word of mouth friends decide to churn together. Through the analysis of temporal changes in the social network structure, the system is capable of detecting clusters of people displaying a collective change in usage patterns leading to churn. The system will alert the service provider of such clusters, pinpointing negative word-of-mouth or weakening of group structure (deletion of links along time) and thus facilitate approaching this problem of group churn. This can be done by targeting the central parts of the group (“individual positive hot spots”, like hubs or authorities or any users with a high social rank) to proactively react against the negative word of mouth, or trying to influence the churning group at large using carpet incentives (approaching a big percentage of the group with incentives). The system may employ social VIP analysis to detect churn. For example, the system may be configured to detect an abrupt change in the social VIP rank of a group of interconnected users, which would indicate churning behavior in that group.

This technique can be used for the prevention of individual churn as well. Today, when churn of a single individual is detected, this individual may be targeted (depending on his financial value to the service provider). With the use of the system, instead of acting on the individual, the service provider will be able to target the individual's environment to create anti-churn forces. For example, if a user declines in MMS usage, the operator can approach other customers in the user environment with incentives of innovative usage of MMS. Beyond mitigating the specific churn, this approach can proactively prevent bad word of mouth and group churn. Namely, it has the benefit of influencing not just the churning customer but potentially others in his neighborhood.

It should be noted that the detection of changes in behavior indicative of churn is dependent on the particular service provider. Churn detection is a standard procedure for service providers since it is very important to keep existing customers. Service providers implement churn detection using standard procedures from data mining or using proprietary software. The important innovation is in that once a churning, customer is detected, the system is employed in analyzing the customer's neighborhood on the social network, to determine whether this churning behavior is an individual decision or whether it is affecting (or is being affected by) an entire group of people.

Further, it is important to note that the current practice of churn prevention is based on non-granular methods by which a big population of customers is treated. Usage of social network analysis can enable an iterative process by which fewer customers need to be approached. The service provider can target influential individuals (i.e., those users with a high social VIP rank, as explained above), lessening the churn of others through good word of mouth and social influence instead of direct incentives. Thus, the service provider can work with a more focused population instead of targeting the group of all potential churning customers, thus yielding better response rates and lower expenditure.

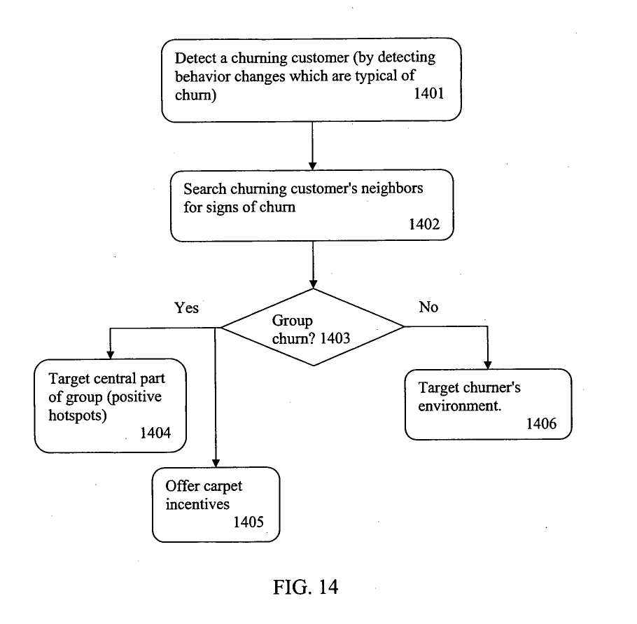

The analysis process for preventing viral collapse is summarized in FIG. 14. In step 1401, the system attempts to detect churning customers by detecting behavioral changes which are typical of churn. Such behaviors may include, for example, decreased usage of the network service. Other behaviors are well known to those skilled in the art of implementing network services. In step 1402, the system then checks to see whether that customer's neighbors (i.e. users within that customer's cluster) are also exhibiting signs of churn. Based on the results of steps 1401 or 1402, the system determines whether an entire group is collectively churning in step 1403. If the system detects group churn, the service provider may decide to either target the most influential or most connected members of that group with incentives in step 1404, or may decide to offer incentives to a large percentage of that group as shown in step 1405. If the system does not detect group churn in step 1403, but rather individual churning behavior, the service provider can then target the churner's environment by offering incentives to the churner, the churner's neighbors on the social network, or both, as shown in step 1406.

### Network Management and Quality Assurance

The system can also provide network management and quality assurance. There can be many failures in a mobile network or any other kind of electronic service on a daily basis. Using the social VIP algorithm, each customer and link between customers on the social network can be rated according to the impact that a failure in this link could have on other subscribers. This is passed on to the service provider, helping in prioritizing the correction of failures. Further, the system may show adoption managers the higher priority customers to treat on time. Real time action is crucial in many applications where loss of context results in loss of interest and further creating bad word of mouth due to the connected nature of the service population. As an example, a customer in a sports event trying to send a great scene and failing may desert the transaction altogether and not retry seven hours later when the problem has been solved, since the game result is known or the scene was shown on TV.

Further, the completion of transactions with high social value is proactively assured, using customer notification and training, technical actions, teasers, etc. For example, the system can list the top 10 failing transactions that have a high social potential via propagation. Customer care can then act upon those transactions by treating users (fixing end points problems, solving education barriers etc.), treating the infrastructure (rebooting a server for example), etc.

The system will further be able to provide a “health picture” of the network by showing the level of connectivity between network areas, identifying clusters with a high percentage of customers with problems, temporarily disconnected customers etc. The resulting visibility can be used for helping to focus resolution processes, indicating the correct time for a marketing campaign etc.

### Campaign Effectiveness

The system further identifies optimal candidates for campaigns using the social VIP rank described hereinabove to improve campaign effectiveness. The system further tracks the propagation of adoption changes as described in the section on rank evolution above to identify positive word-of-mouth. The campaign can then be managed with a phased approach, taking advantage of the viral effect. The system gives an accurate measure of marketing campaign effectiveness, by tracking the adoption changes of the users who were the targets of the campaign, as well as their neighbors on the social network. This helps in optimizing marketing campaigns as the service provider needs to approach only customers in the neighborhood that have not shown increase in adoption. The end result is propagated using fewer resources and a faster and higher response rate.

Further, the on-line network health visibility gained by the operator (as explained in the preceding section) facilitates informative decisions about when to initiate campaigns. For example, if technical problems of specific customers have segmented the network, the operator may decide not to send messages to a group of customers so as not to miss out on the potential word of mouth propagation. Another example would be to track clusters that suffer high failure rates during campaigns and either focus customer care operation on them or decide to focus efforts on other clusters with potential higher response rates.

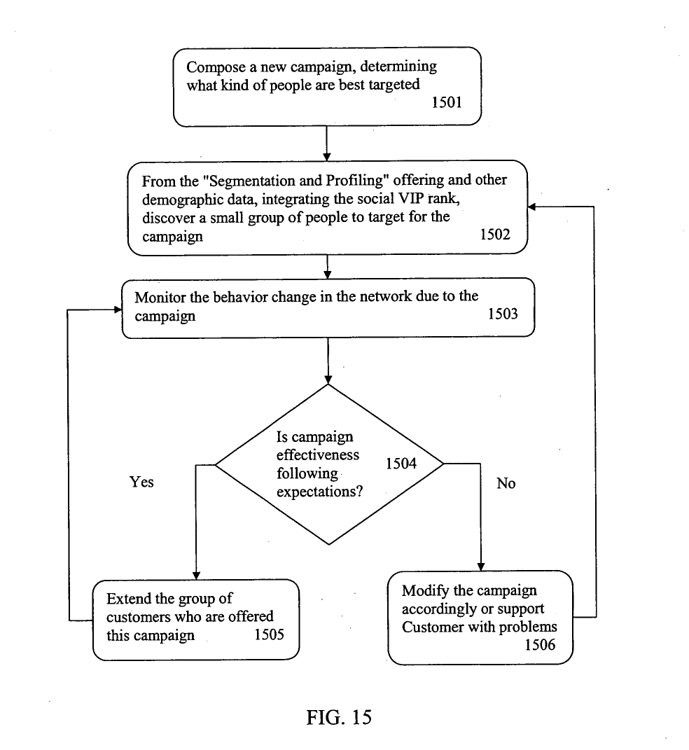

The campaign effectiveness analysis process is summarized in FIG. 15. In step 1501, the service provider creates a new campaign (e.g., a new service offering), and determines what kind of people it would like to reach. In step 1502, the system uses the “segmentation and profiling” method, to be described below, in conjunction with social VIP ranking and demographic data to discover a small group of people to target for the campaign. In step 1503, the system monitors the behavior change in the network due to the campaign, using such techniques as rank evolution. In step 1504, the system determines whether the campaign's effectiveness is meeting expectations. If the campaign is meeting expectations, the system can then suggest additional users to target with offers, as shown in step 1505. The system may then return to step 1503 to monitor the behavior changes in the network and track the campaign's effectiveness. However, should the campaign's effectiveness not be meeting expectations, the service provider may modify the terms of the campaign or attempt to resolve any problems the currently targeted customers may have with the new offering, as shown in step 1506. From there, the system returns to step 1502 and determines a new group of people to target with the modified campaign.

### Automatic Provisioning

Provisioning is the enabling, by the operator, of a certain service. This includes but is not limited to new features introduced into the offering by a mobile communication provider. Provisioning is potentially a costly action, since it might require providing the users with new software, changing various databases on the provider's side or other requirements. When provisioning a customer, the system alerts the mobile operator about the customer's neighborhood up to a certain degree of separation (for example, 3 degrees of separation means up to the neighbors of the neighbors of the customer, inclusive). The operator may decide to automatically provision the neighbors. The system also alerts the operator about group anomalies and inconsistencies resulting from the provisioning.

Thus enabling and provisioning, which are costly operations, are not done all at once on the entire network whenever a new service is introduced. Instead, the system provides the capability for a usage based propagation of the automatic process from certain points in the network. Automatic provisioning further increases the likelihood of success when the originally provisioned customer initiates interaction with a peer as the peer will not need to ask to be provisioned explicitly and the transaction could flow naturally.

Consider the following example, from the realm of mobile communication. A customer requests to join a service. After several hours of use he contacts customer care and complains about a failure. The root cause appears to be the wrong software version on his handset and customer care thus sends him a software update through the network communication medium. Using the system, customer care could identify his peers with the same handset model and update their software as well.

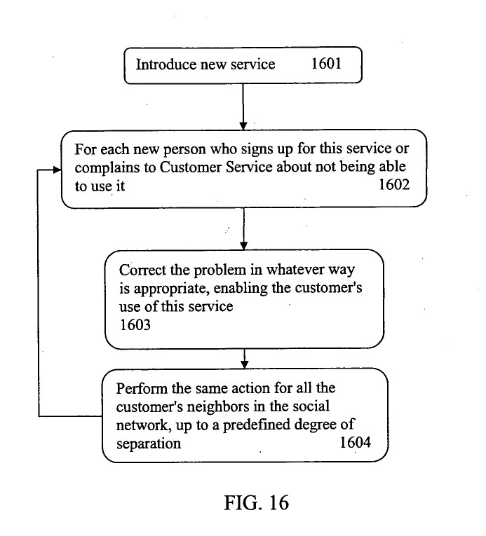

The automatic provisioning analysis process is summarized in FIG. 16. In 1601, the network service provider introduces a new service. In step 1602, the system collects a list of users who either signed up for the new service (which may simply constitute attempting to use the service), or users who call the customer service representative of the service provider complaining of a problem with the new service. The system may also employ the social VIP analysis to determine which customers to provision with the new service. In step 1603, the service provider takes whatever steps necessary to enable that customer's use of the service. This may include setting up a first time customer of the new service, or fixing any problems of a pre-existing user of the new service. In step 1604, the network service provider may attempt to perform the same action taken in step 1603 with all the customer's neighbors in the social network (to a predefined degree of separation), in order to ensure that the customer can use the service with all her neighbors, and to promote adoption of the new service.

### User Patterns

The system can identify special usage patterns such as users who only receive and never send, or those who receive and send but do not create content (e.g. never send pictures created with their handset camera), pinpointing usability, pricing or technical capability barriers to name but a few. User patterns analysis is based on the premise that within their social structure, people can be identified as outliers (exceptions) by showing a behavior or attribute which is not consistent with their social environment. The system thus scans interacting customers looking for individuals with a different behavior than the majority in their cluster. The system may also employ social VIP analysis to prioritize which usage patterns to analyze.

Further, the system includes a set of pre-defined user patterns that can be identified in any social network graph. Using this resource of “bad practice” patterns, the system can quickly identify problematic customers. As an example, consider a pattern in which a certain customer is the only person to communicate with a group of people, creating a star like structure. This is very common in MMS networks and can be acted upon by the service provider (using incentives, campaigns etc) to raise the interaction of the customers with others.

### Segmentation and Profiling

This capability requires the active participation of the service provider, since here the data analyzed is not gathered passively from log files but from specially generated A2P transactions (messages, such as but not limited to SMS or MMS on mobile networks, containing specially targeted content or teasers sent from the service provider to select individuals). Using communication logs, the leakage of these A2P transactions, the propagation of content among customers is tracked.

The system tracks A2P messages and the path they take on the social network as they are forwarded by the original customers to their friends across the social network, and gain insight into flow of information in the network, joint interests etc. For example, if a certain customer received a football movie from an A2P application and forwarded it to 3 of his friends, we can assume that those friends also take interest in football. The advantage here is that the peers do not need to do anything for the service provider to learn about them. In order to fine tune the sensitivity of the method, the system can track communication over time (namely, football clips are being sent along time) or cross communication between customers (namely the target profile customer receives football message from several other customers). The system may also employ the social VIP analysis to rank and prioritize which customer groups to segment and profile.

Based on the identified content type, user profiling information (for example, all users interested in soccer) can be enriched. The underlining idea is that one's friends are the best profilers of one's interests through their social interaction.

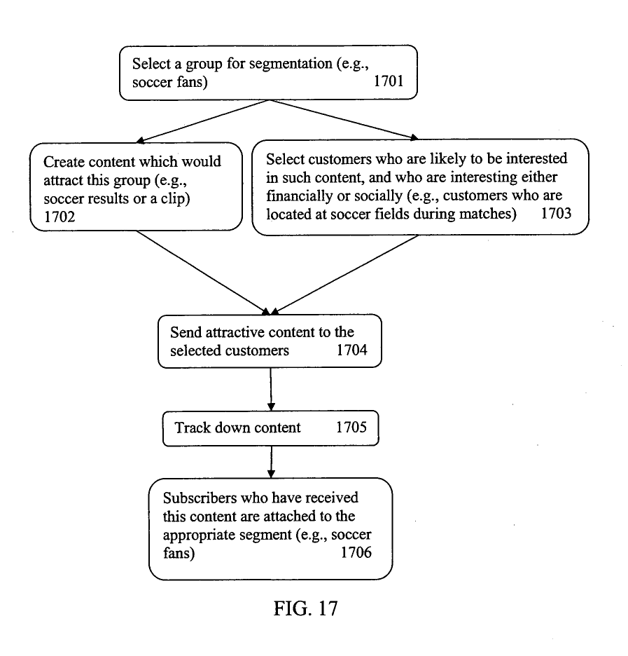

The segmentation and profiling analysis process is summarized in FIG. 17. In step 1701, the network service provider selects a group for segmentation. In step 1702, the network service provider creates content which would attract this group (e.g. information or multimedia files which can be transmitted from person to person). In step 1703, the system selects customers who are likely to be interested in the content generated in step 1702, and who are preferably of high social VIP rank. In step 1703, the system then sends the content generated in step 1702 to the customers identified in step 1703. In step 1705, the system can then track the content as it is forwarded from person to person. In step 1706, the system collected the list of users who have received the content as being within the group targeted for segmentation.

### Hardware Embodiments

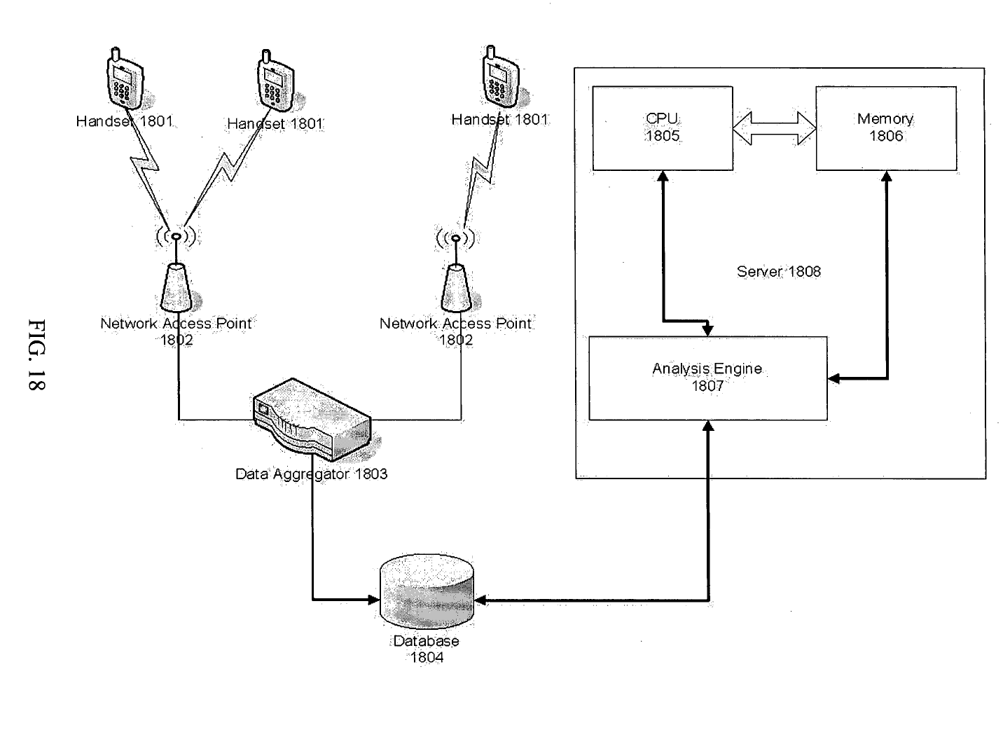

FIG. 18 depicts a block diagram of the system, according to one embodiment of the invention. Handsets 1801 represent the individual devices that a customer may use to access the network service. In the context of mobile telephony, these handsets are generally mobile phones, but may also be wireless internet adapters, smartphones, etc. Network Access Points 1802 are in direct two-way communication with Handsets 1801 and provides access to the network services such as voice, MMS, SMS, etc.

It is to be understood by one skilled in the art that Handsets 1801 and Network Access Points 1802 are merely examples from the field of mobile telephony and that the present invention may be implemented in a wide variety of contexts in which two-way communication is possible, or a social network graph can be constructed. Such contexts include, but are not limited to, fixed-line telephony, interactive television, and internet networks employing VoIP, e-mail, online gaming, and web based services. In such contexts, Handsets 1801 and Network Access points 1802 may be replaced with computers or set-top boxes, and their respective networking hardware.

Data Aggregator 1803 is a centralized unit that collects all transaction data occurring by means of Handsets 1801 and Network Access Points 1802. Multiple Data Aggregator 1803 units may be employed if the user base is naturally segmented by geography or type of service used. Database 1804 may store the transaction data collected by Data Aggregator 1803 in either a log file, or in a relational or object-oriented database format. Other data storage formats may also be used.

Analysis Engine 1807 analyzes the data stored in Database 1804 and performs the social network graph construction and analysis of the type described herein. Preferably, Analysis Engine 1807 is a series of computer executable instructions stored on a computer readable medium and executed on CPU 1805. CPU 1805 is also coupled to Memory 1806, which may be employed in the execution of the analysis performed by Analysis Engine 1807. The social network graphs constructed by Analysis Engine 1807 as well as the analysis results may be stored in Database 1804, or in some other location.

Analysis Engine 1807, CPU 1805, and Memory 1806 may all be integrated into Server 1808, which may be coupled to Database 1804 as well as the network. Database 1804 may also be placed inside Server 1808, with no loss of functionality. Alternatively, Analysis Engine 1807 may operate as a stand alone hardware device, capable of directly accessing Database 1804, or the network itself.

The present invention has been described with certain degree of particularity. Those versed in the art will readily appreciate that various modifications and alterations may be carried out without departing from the scope of the following claims.

1. A method of using social network analysis to enhance the efficiency and/or revenue of a network service comprising:
collecting a record of transactions made between users of said network service;
creating a graph of the social network of said users by representing each user as a node in the graph and each transaction as a directed or undirected edge;
weighing each node and edge in said directed graph with at least one of demographic, geographic, financial, and transaction detail data;
ranking each node in said directed graph according to its relative importance in said directed graph and to its social attributes within said social network;
analyzing said directed graph using the ranking of at least one of said nodes to determine an opportunity to increase the efficiency and/or revenue of said network service; and
modifying either a technical implementation or a term of service with respect to at least one of said users of said network service corresponding to said at least one node in accordance with said opportunity.

2. The method of claim 1, wherein said step of modifying is directed toward the user associated with a node whose rank was determined.

3. The method of claim 1, wherein said step of modifying is directed toward the environment of the user associated with a node whose rank was determined.

4. The method of claim 1, wherein said opportunity is determined by:
comparing the social networking graphs of two communications technologies to detect edges present in only one graph; and
ranking said edges present in only one graph according to social and financial importance.

5. The method of claim 4, further comprising:
providing incentives to adopt one of said two communications technologies to at least one user associated with an edge of high rank.

6. The method of claim 1, wherein the rank of said each node of said graph is monitored over time.

7. The method of claim 1, wherein said step of analyzing said graph to determine said opportunity comprises detecting incompatible attributes within a cluster of said users.

8. The method of claim 7, wherein said step of modifying comprises resolving incompatibilities within said cluster.

9. The method of claim 1, wherein said step of analyzing said graph to determine said opportunity comprises detecting the source of the spread of inappropriate content transmitted on said network service using said directed graph.

10. The method of claim 9, wherein said step of modifying comprises preventing the spread of said inappropriate content.

11. The method of claim 1, wherein said step of analyzing said directed graph to determine said opportunity comprises detecting fraud on said network service.

12. The method of claim 11, wherein said step of modifying comprises preventing the furtherance of fraud on said network service.

13. The method of claim 1, wherein said step of analyzing said directed graph to determine said opportunity comprises preventing chum.

14. The method of claim 13, wherein said modifying step comprises providing incentives to users in accordance with said ranking step.

15. The method of claim 1, wherein said step of analyzing said directed graph to determine said opportunity comprises preventing viral collapse.

16. The method of claim 15, wherein said modifying step comprises providing incentives to users in accordance with said ranking step.

17. The method of claim 1, wherein said step of analyzing said directed graph to determine said opportunity comprises determining which of said users to target in a campaign and monitoring the effectiveness of said campaign.

18. The method of claim 1, wherein said step of analyzing said directed graph to determine said opportunity comprises segmenting and profiling a subset of said users by tracking a given transaction as it propagates through the social network.

19. The method of claim 1, wherein said step of modifying with respect to said at least one of said users of said network service is prioritized according to said ranking of the nodes associates with said users.

20. The method of claim 1, wherein said step of analyzing said directed graph to determine said opportunity comprises efficiently managing said users of said network service based on said directed graph.

21. A method of using social network analysis to enhance the efficiency and/or revenue of a network service comprising:
collecting a record of transactions made between users of said network service;
creating a graph of the social network of said users by representing each user as a node in the graph and each transaction as a directed or undirected edge;
weighing each node and edge in said graph with at least one of demographic, geographic, financial, and transaction detail data;
ranking each edge in said graph according to its relative importance in said directed graph and to its social attributes within said social network;
analyzing said graph using the ranking of at least one of said nodes to determine an opportunity to increase the efficiency and/or revenue of said network service; and
modifying either a technical implementation or a term of service with respect to at least one of said users of said network service associated with each said edge in accordance with said opportunity.

22. The method of claim 21, wherein said step of modifying with respect to said at least one of said users of said network service is prioritized according to said ranking.

23. A system for enhancing the efficiency and/or revenue of a network service comprising:
a database storing a record of transactions made between users of said network service; and
a server comprising a CPU, memory, and an analysis engine, wherein the server is configured to:
create a graph of the social network of said users by representing each user as a node in the graph and each transaction as a directed or undirected edge;
weigh each node and edge in said graph with at least one of demographic, geographic, financial, and transaction detail data;
rank each node in said graph according to its relative importance in said directed graph and social attributes within said social network; and
analyze said graph using the ranking of at least one of said nodes to determine an opportunity to increase the efficiency and/or revenue of said network service.
